(19) United States
(12) Patent Application Publication
(10) Pub. No.: US 2010/0313822 A1
(43) Pub. Date: Dec. 16, 2010

(54) FOLDABLE PET CAGE

(75) Inventor: Ching-Tzung HUANG, Taipei City (TW)

Correspondence Address: EGBERT LAW OFFICES, 412 MAIN STREET, 7TH FLOOR, HOUSTON, TX, 77002, US

(73) Assignee: YOUNGTICO Co., LTD., Taipei City (TW)

(21) Appl. No.: 12/484,194

(22) Filed: Jun. 13, 2009

(51) Int. Cl. A01K 1/03

(52) U.S. Cl. 119/453; 119/474; 119/481

(57) ABSTRACT

The present invention provides a kind of foldable pet cage, including a folding back frame, a rotatable seat board, a decorating facet and a foldable fence component. The rotatable seat board has a supporting board and a pivot side hinged on the landing board of the folding back frame so that the rotatable seat board can be rotated to the horizontal using status or to the vertical position to close the folding space of the folding back frame. The decorating facet is configured on the outside of the rotatable seat board. The foldable fence component has a front fence and two side fences. When folded, the foldable pet cage can be transformed into a decorative ornament, and as the fence components are completely housed and concealed, there will be no odor diffusion.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a kind of pet cage, and more particularly to an innovative foldable pet cage which, when folded, can have functions of decoration, enclosing, and hiding.

2. Description of Related Art Including Information Disclosed Under 37 CFR 1.97 and 37 CFR 1.98

A pet cage is a necessary product for those people who feed pets, like dogs and cats, at home. In the past, pet cages were usually placed in the outside garden or corridor. Nowadays, as many people dote on the pets very much, pets are getting more and more respect at home. Hence, nowadays many people move the pet cage into the house, or set an outdoor pet cage and an indoor enclosure-style pet cage at the same time to house the pet under different situations.

However, an indoor pet cage is needed only temporarily for many people. When not used, the pet cage will become a big and ugly encumbrance that occupies the room and may even generate disgusting odor; thus, related manufacturers have developed a kind of foldable pet cage. However, the design of currently known foldable pet cages still has problems.

First, in the traditional foldable pet cages, the folding function is enabled just through a detachable or bendable configuration between the fences. Hence, when folded, although it looks flat, it is still easily identified as a pet cage. As it is inevitable that the fences may have wear traces caused by scratching or biting by the pet after a certain period of usage, it may be offensive to the eye. Hence, unless it is folded and hidden in a secluded utility room, the pet cage may look uncomfortable no matter it is placed in the guestroom, kitchen or bedroom.

Moreover, as the fences of the traditional pet cage are exposed when folded, the odor caused by scratching, biting, and shifting by the pet may diffuse and consequently affect the environmental health and quality.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The present invention has improved efficacy.

The foldable pet cage disclosed by the present invention adopts an innovative and unique structure constituted by the folding back frame, rotatable seat board, decorating facet and foldable fence component. Because, when folded, the foldable fence components will be housed and concealed inside the space formed by the folding back frame and rotatable seat board, and on the outside, through design of the appearance of the folding back frame and the rotatable seat board as well as the decorative style of the decorating facet, the foldable pet cage can be transformed into a decorative ornament. Hence, it is suitable to be placed at any indoor position and can have decorating and esthetic functions.

As the fence component can be completely housed and concealed within the space formed by the folding back frame and rotatable seat board, there will be no odor diffusion.

The present invention can also generate new functions.

First, through the structure of the ceiling board of the folding back frame, being configured with a placing top facet, when folded, the foldable pet cage can act as a shelf to be placed with decorative articles and daily articles. Hence, it has added value.

Second, through the structure of the ceiling board of the folding back frame, being configured with a carrying handle so that the whole foldable pet cage can be lifted, when folded, the foldable pet cage can be moved more conveniently.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of a preferred embodiment of the foldable pet cage structure of the present invention.

FIG. 2 shows an illustration of the folding of the foldable pet cage of the present invention.

FIG. 3 shows a perspective view of the folding status of the foldable pet cage of the present invention.

FIG. 4 shows a sectional view of the folding status of the foldable pet cage of the present invention.

FIG. 5 shows a perspective view of the unfolded using status of another embodiment of the foldable pet cage structure of the present invention.

FIG. 6 shows a perspective view of the folded status of another embodiment of the foldable pet cage of the present invention.

FIG. 7 shows a perspective view of an embodiment of the present invention with the folding back frame ceiling board additionally configured with a carrying handle.

FIG. 8 shows a perspective view of another embodiment of the foldable pet cage structure of the present invention.

### DETAILED DESCRIPTION OF THE INVENTION

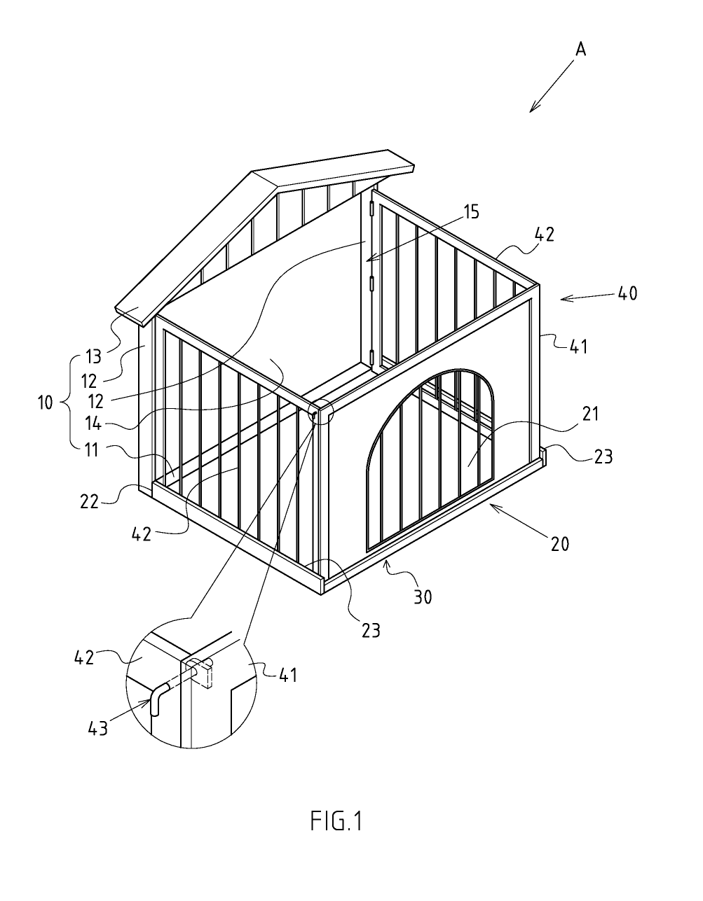

FIGS. 1-4 depict preferred embodiments of the foldable pet cage of the present invention. Such embodiments are for description purposes only. The patent application is not restricted by this structure.

The foldable pet cage A includes a folding back frame 10, which is a vertically configured rectangular frame, and which is configured with a landing board 11, two side boards 12, a ceiling board 13, a back board 14 and a folding space 15. The ceiling board 13 of this embodiment is configured as an upside-down “V” shape to form a roof style.

A rotatable seat board 20 includes a supporting board 21 and a pivot side 22. The pivot side 22 is to be hinged onto the landing board 11 of the folding back frame 10, so that the rotatable seat board 20 can be rotated to the horizontal position for usage, or to the vertical position to close the folding space 15 of the folding back frame 10.

A decorating facet 30 is configured on the opposite side of the supporting board 21 of the rotatable seat board 20. The decorating facet 30 will be exposed outside when the rotatable seat board 20 is rotated to the vertical position.

A foldable fence component 40 includes at least one front fence 41 and two side fences 42. One side of the front fence 41 is hinged on the front side of the rotatable seat board 20, so that the front fence 41 can be rotated to a horizontal position for the folded status, or to a vertical position for the using status. One side of each of the two side fences 42 is hinged on the outside of the two side boards of the folding back frame 10, so that the two side fences 42 can be rotated to be housed inside the folding space 15 of the rotatable seat board 20 for the folded status, or be rotated to sit on the supporting board 21 of the rotatable seat board 20 and join with the front fence 41 to form a [symbol] -shaped enclosure for the using status. Moreover, a positioning component 43 is configured between the front fence 41 and the two side fences 42 so that the fences can be connected and positioned. The positioning component 43 can be embodied in various forms, such as male and female locker, bolt, linking tape, magnetic matching parts, and screw lock component.

Furthermore, the two sides of the supporting board 21 of the rotatable seat board 20 are configured with protruding stoppers 23, so that, when the two side boards 12 are rotated to sit on the supporting board 21 for the usage status, they can be stopped by the protruding stoppers 23 and be limited.

Furthermore, the decorating facet 30 is configured with any of the following decorating ornaments or combinations: plane or 3D patterns, graphics, sculptures, frame pictures, lamp houses, and leather.

The above configurations constitute the design of the present invention. The usage and folding situation of the present invention is described as below:

Referring to FIG. 1, the foldable pet cage A is unfolded in a using status. In this status, the folding back frame 10 is positioned on a vertical angle. The rotatable seat board 20 is rotated to the horizontal angle, so that its supporting board 21 faces upward. The front fence 41 and two side fences 42 of the foldable fence component 40 are all in a vertical and unfolded position and are connected together to form a [symbol] -shaped enclosure, and further join the folding back frame 10 to from a □-shaped enclosure. In this way, a pet is put inside this enclosure to limit its range of activity.

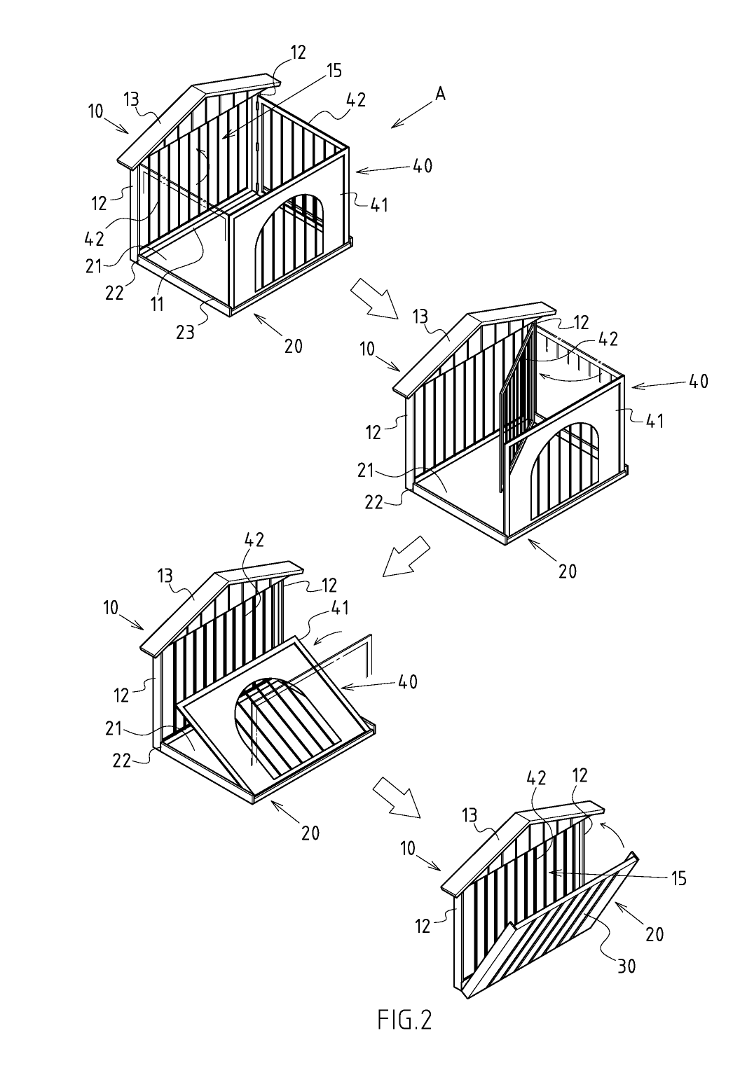

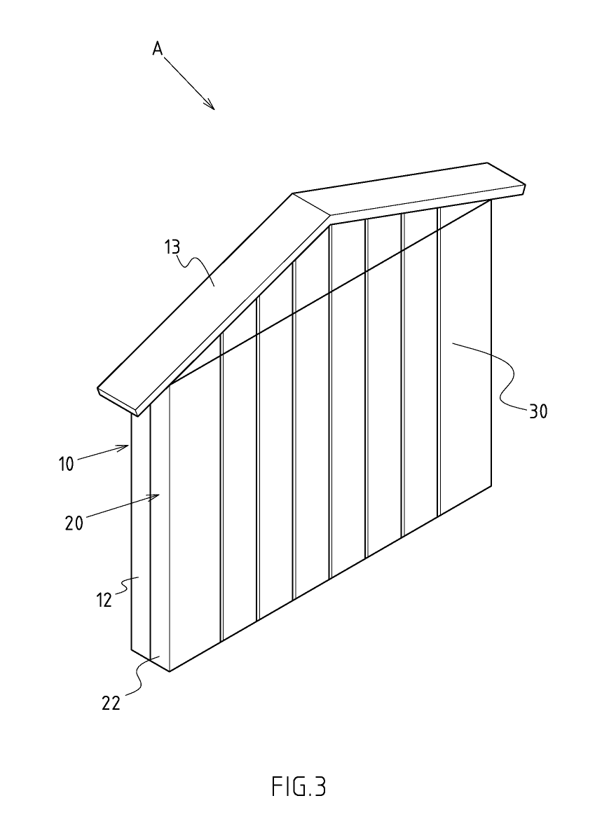

Referring to FIG. 2, when it is needed to fold the foldable pet cage A, the two side fences 42 of the foldable fence component 40 can be rotated to go into the folding space 15 of the folding back frame 10. Then, the front fence 41 can be folded to sit horizontally on the supporting board 21 of the rotatable seat board 20. Furthermore, the rotatable seat board 20 is rotated to the vertical position to close the folding space 15 of the folding back frame 10 (as shown in FIG. 3, 4).

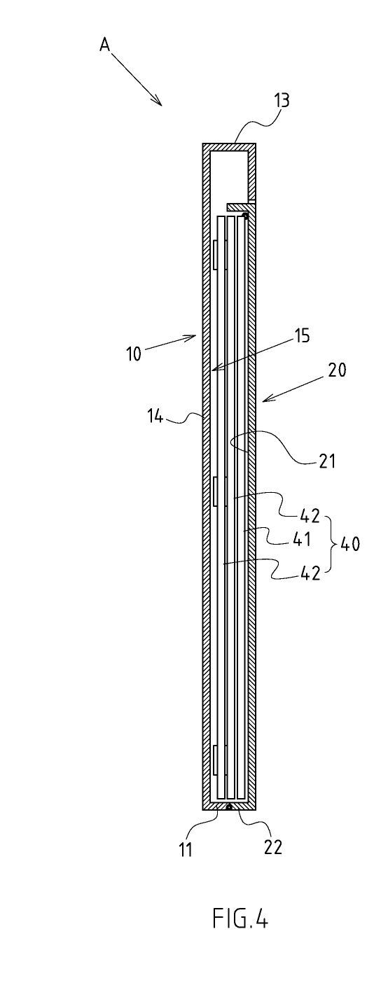

On the other hand, when the foldable pet cage A is in a folded status as shown in FIGS. 3 and 4, the front fence 41 and the two side fences 42 of the foldable fence component 40 are completely contained and hidden inside the space formed by the folding back frame 10 and rotatable seat board 20. Hence, in this status, the foldable fence component 40 cannot be seen from outside.

With regard to the outside appearance of the foldable pet cage A in the folded status (as shown in FIG. 3), only the folding back frame 10 and the rotatable seat board 20 are seen. Through style designing of these two components, it can be developed into a kind of decorating ornament to escape from the shape of the pet cage. As disclosed in FIG. 3, the ceiling board 13 of the folding back frame 10 is configured in an upside-down V shape to simulate the roof, and the rectangular shapes of the folding back frame 10 and rotatable seat board 20 form the body of a house. The decorating facet 30 is configured with spaced straight stripes to simulate a wooden house. In this way, when folded, the foldable pet cage A becomes a house-style ornament which is suitable to be placed at any indoor position.

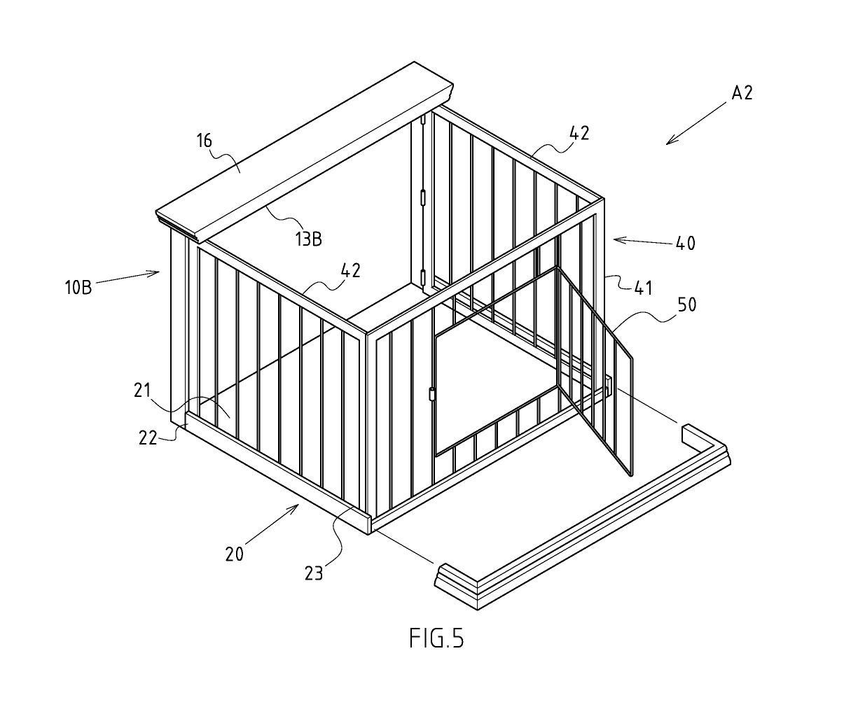

FIG. 5 shows another embodiment of the foldable pet cage A2. In this embodiment, the ceiling board 13B of the folding back frame 10B is formed with a placing top facet 16. The placing top facet 16 can be a plane or a stepped shape, or in the shape of a shelf. Through configuration of the placing top facet 16, when folded, the foldable pet cage A can have the function of a shelf, to be placed with decorating ornaments or daily articles.

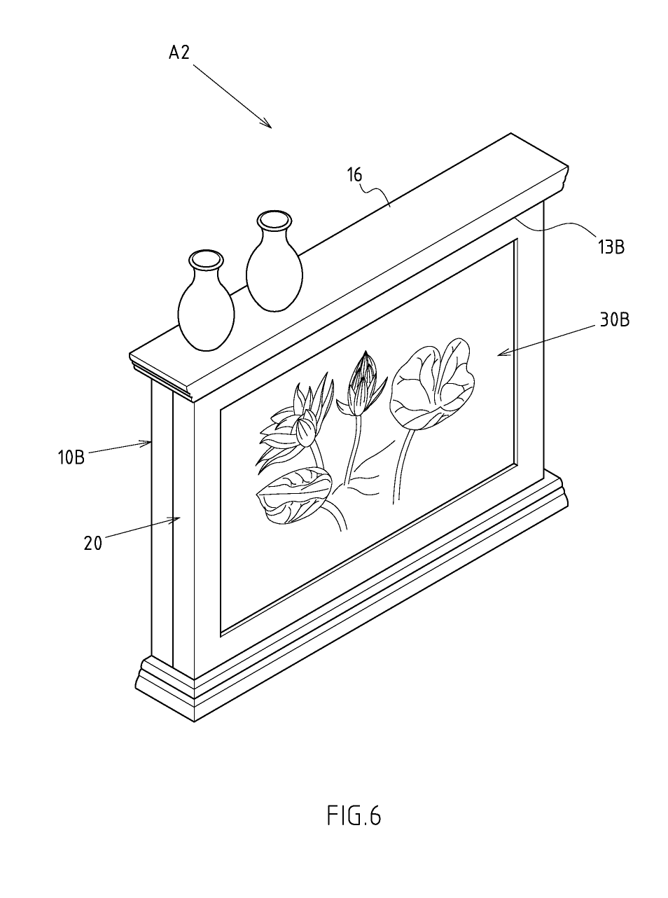

Furthermore, in this embodiment, either the front fence 41 or any of the side fences 42 of the foldable fence component 40 can be configured with a movable door plate 50, to form an opening for the pet to go in and out. Moreover, as disclosed by FIG. 6, the decorating facet 30B can be configured in a frame picture style, so that the foldable pet cage A2 can be folded to become a picture frame (or photo frame).

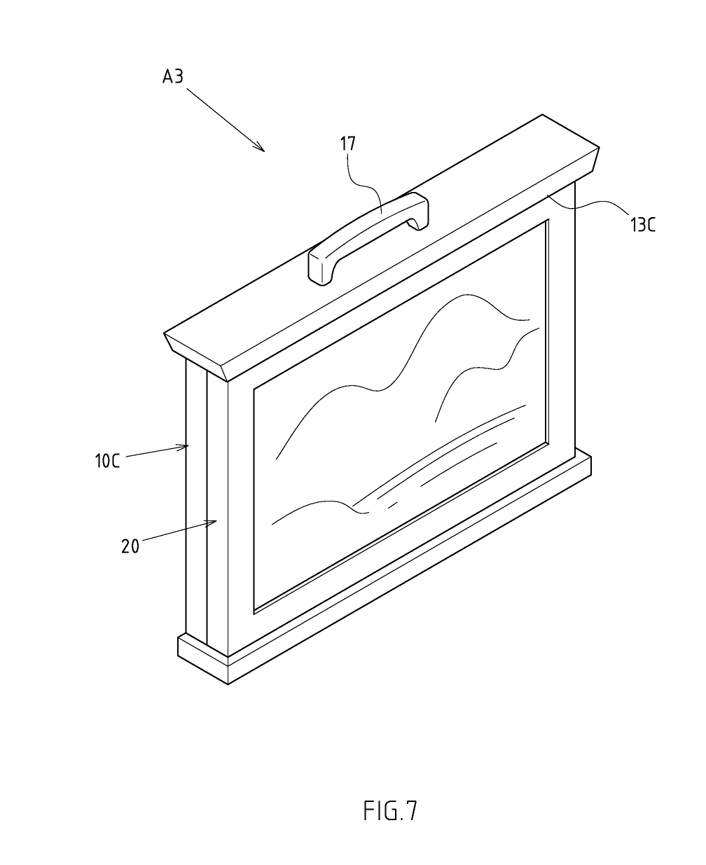

Furthermore, referring to FIG. 7 for the foldable pet cage A3, the ceiling board 13C of the folding back frame 10C can also be configured with a carrying handle 17, so that the whole foldable pet cage A3 can be lifted for more convenient movement.

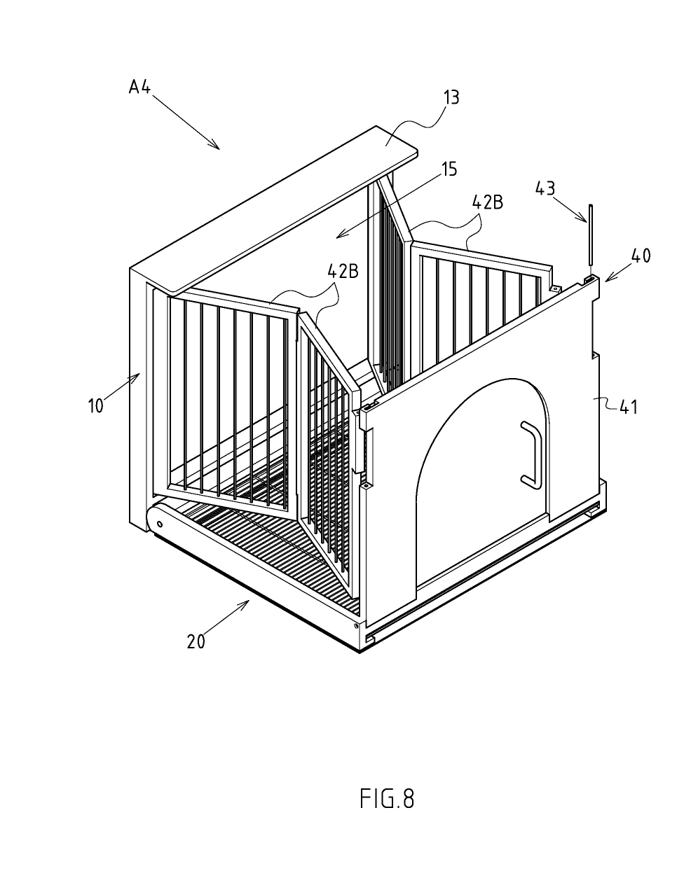

Referring to FIG. 8 for the foldable pet cage A4, the two side fences 42B of the foldable fence component 40 are configured in the form of a bendable frame plate (can be in two-plate folding or multi-plate folding form). In this way, when folding the two side fences 42B, they can be bent and placed into the folding space 15 of the folding back frame 10, so as to provide another configuration style for implementation.

1. A foldable pet cage, comprising:
a folding back frame, being a vertically configured frame shape and defining a landing board, two side boards, a ceiling board, a back board and a folding space;
a rotatable seat board, having a supporting board and a pivot side, said pivot side being hinged onto the landing board of the folding back frame, so that the rotatable seat board rotates to a horizontal position for usage or to a vertical position to close the folding space of the folding back frame;
a decorating facet, configured on the opposite side of the supporting board of the rotatable seat board, said decorating facet being exposed outside when the rotatable seat board is rotated to the vertical position;
a foldable fence component, having a front fence and two side fences, said front fence having one side hinged on the front side of the rotatable seat board, said front fence rotated to a horizontal position for the folded status or to a vertical position for the using status, the two side fences having respective sides hinging on the outside of the two side boards of the folding back frame, so that the two side fences rotate to be housed inside the folding space of the rotatable seat board for the folded status to sit on the supporting board of the rotatable seat board and join with the front fence to form an enclosure for the using status; and
a positioning component is configured between the front fence and the two side fences so that the fences can be connected and positioned.

2. The pet cage defined in claim 1, wherein the ceiling board of the folding back frame is configured in an upside-down V shape.

3. The pet cage defined in claim 1, wherein the ceiling board of the folding back frame is configured with a placing top facet.

4. The pet cage defined in claim 1, wherein the decorating facet is configured with a decorating ornament selected from a group consisting of: plane or 3D patterns, graphics, sculptures, frame pictures, lamp houses, and leather.

5. The pet cage defined in claim 1, wherein the two sides of the supporting board of the rotatable seat board are configured with protruding stoppers, so that when the two side boards are rotated to sit on the supporting board for the usage status, they can be stopped by the protruding stoppers and be limited.

6. The pet cage defined in claim 1, wherein either the front fence or any of the side fences of the foldable fence component is configured with a movable door plate, to from an opening for the pet to go in and out.

7. The pet cage defined in claim 1, wherein the ceiling board of the folding back frame is configured with a carrying handle, so that the whole foldable pet cage can be lifted for convenient movement.

8. The pet cage defined in claim 1, wherein the two side fences of the foldable fence component are configured in the form of a bendable frame plate.
